(19) United States
(12) Patent Application Publication
(10) Pub. No.: US 2003/0071805 A1
(43) Pub. Date: Apr. 17, 2003

(54) Powering down display screens of processor-based systems

(76) Inventor: Randy P. Stanley, Aptos, CA (US)

Correspondence Address: TROP PRUNER & HU, PC, 8554 KATY FREEWAY, SUITE 100, HOUSTON, TX, 77024, US

(21) Appl. No.: 09/981,104

(22) Filed: Oct. 17, 2001

(51) Int. Cl. G09G 5/00

(52) U.S. Cl. 345/211

(57) ABSTRACT

The transition of a processor-based system from a higher power consumption state to a lower power consumption state may be accomplished by progressively dimming the display. By avoiding an abrupt transition of the display to black, users are less likely to notice the transition and to simply operate a key to transition the system back to the higher power consumption state simply to insure that their computers have not failed. As a result, users may be given progressive notice of the transition to a lower power consumption state and the likelihood that consumers will simply operate a key, having been attracted by the abrupt display transition, is reduced. This reduction of automatic key operation may reduce the power consumed by processor-based systems.

### BACKGROUND

This invention relates generally to processor-based systems and particularly to techniques for conserving the amount of power consumed by those processor-based systems.

Because of the large number of processor-based systems, considerable effort has been made to reduce their power consumption. For environmental reasons, it is desirable to reduce the power consumption of all processor-based systems. Particularly with mobile or battery powered processor-based systems, the reduction of power consumption may increase the amount of time that that processor-based system may be operated without recharging its batteries. Increasing the time between charging is a considerable marketing advantage.

While a wide variety of techniques are available for reducing power consumption, many of these techniques involve at least temporarily reducing the operation of a variety of components including the processor and the display. For example, a processor-based system may detect the amount of activity going on in the system. When activity is absent for a sufficient period of time, the display may be blanked to conserve power.

Any resumption of user activity recognized by the operating system causes the processor-based system to resume its normal power consumption state. Changing power consumption states can also increase power consumption. Therefore, it is undesirable to undergo unnecessary or excessive power state transitions.

Thus, it would be desirable to have techniques that enable displays to be effectively powered down.

### BRIEF DESCRIPTION OF THE DRAWINGS

FIG. 1 is a schematic depiction of a processor-based system in accordance with one embodiment of the present invention; and

FIG. 2 is a flow chart for software in accordance with one embodiment of the present invention.

### DETAILED DESCRIPTION

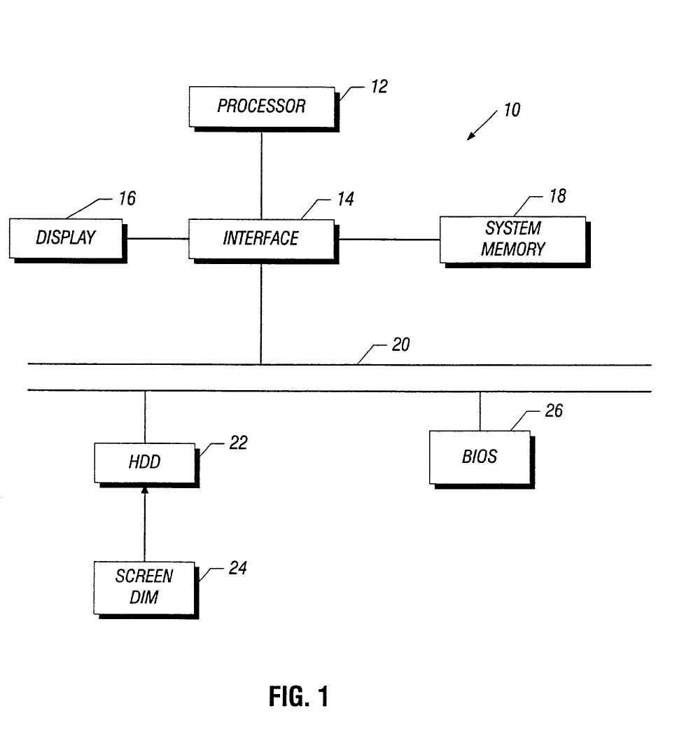

Referring to FIG. 1, a processor-based system 10 may include a processor 12 coupled to an interface 14. The interface 14, which may be a bridge, may be coupled to a display 16 or a display controller (not shown) and a system memory 18. The interface 14 may also be coupled to one or more buses 20. The bus 20 in turn may be coupled to one or more storage devices 22, such as a hard disk drive (HDD). The hard disk drive 22 may store a variety of software, including a screen dim software 24. A basic input/output system (BIOS) memory 26 may also be coupled to the bus 20 in one embodiment. Of course, a wide variety of other processor-based system architectures may be utilized.

The processor-based system 10 may be powered from a wall socket power supply or may be battery powered. Generally, with conventional processor-based systems, a reduced power consumption mode may be implemented after a period of inactivity. One power consumption reduction tactic is to blank the display screen in order to save power in the lower power consumption mode.

The inventor of the present invention realized that commonly what happens in transitioning to a lower power consumption state is that the display screen abruptly is blanked to black. The distinct change in light output and the abrupt action, generally attracts user attention. A common user reaction to this abrupt transition is to instinctively resist the automated change. A typical user instinctive action is to simply operate any key. A key may be pressed even though the user does not need to use the processor-based system at that instant in time.

The net effect of the abrupt display transition and the user's natural response to operate a key is that power consumption is not conserved.

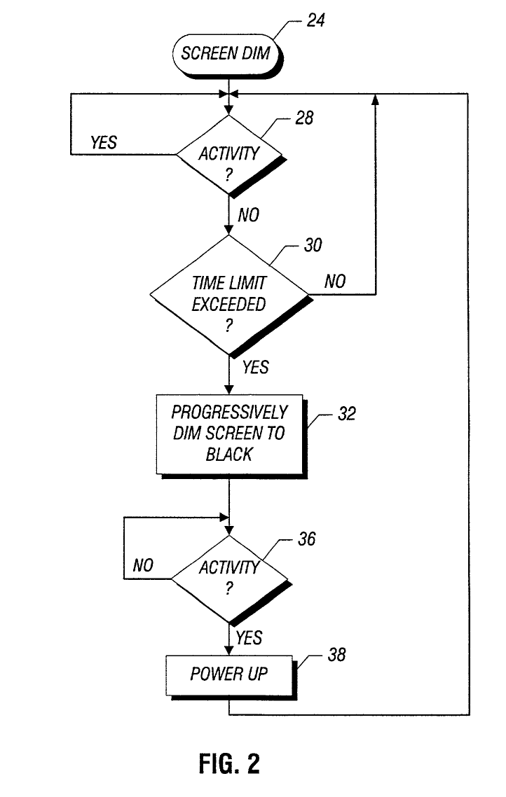

Thus, referring to FIG. 2, the screen dim software 24 determines when a period of inactivity has been detected, as indicated in diamond 28. A check at diamond 30 determines whether a period of inactivity exceeds a pre-determined time limit.

At block 32, the display 16 is progressively dimmed to black. Instead of abruptly converting the screen to display black, the screen is allowed to progressively dim. As a result, the transition is more gradual and is less noticeable by the user. Moreover, users may eventually recognize the progressive dimming as a natural, intuitive power consumption reduction technique. This progressive dimming may be sufficiently distinct that many users may be assured that their computers have not failed, but instead, are in effect, progressively “falling asleep.” Thus, users may recognize a natural transition over time to a black screen. The absence of an abrupt transition may induce users to refrain from instinctively pressing on a key.

At diamond 36, a check determines whether any activity has been detected. If so, the system may be powered up, as indicated in block 38.

In some embodiments, the present invention may be implemented in connection with the Advanced Configuration and Power Interface (ACPI) Specification Revision 1.0, Dec. 22, 1996, available from Intel Corporation, Santa Clara, Calif. Embodiments of the present invention are applicable to a variety of other power consumption techniques as well.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining when a processor-based system is to be transitioned to a lower power consumption state; and
progressively dimming the display screen of the processor-based system.

2. The method of claim 1 including initiating the progressive dimming of the display before implementing the transition to the lower power consumption state.

3. The method of claim 1 including determining whether the processor-based system has been inactive.

4. The method of claim 3 including determining whether the processor-based system has been inactive for a time period exceeding a time limit.

5. The method of claim 1 including powering down the processor-based system to a lower power consumption state after progressively dimming the display screen.

6. An article comprising a medium storing instructions that enable a processor-based system to:
determine when a processor-based system is to be transitioned to a lower power consumption state; and
progressively dim the display screen of the processor-based system.

7. The article of claim 6 further storing instructions that enable the processor-based system to initiate the progressive dimming of the display before implementing the transition to the lower power consumption state.

8. The article of claim 6 further storing instructions that enable the processor-based system to determine whether the processor-based system has been inactive.

9. The article of claim 8 further storing instructions that enable the processor-based system to determine whether the processor-based system has been inactive for a time period exceeding a time limit.

10. The article of claim 6 further storing instructions that enable the processor-based system to power down the processor-based system to a lower power consumption state after progressively dimming the display screen.

11. A system comprising:
a processor; and
a storage coupled to said processor storing instructions that enable the processor to determine when a processor-based system is to be transitioned to a lower power consumption state, and progressively dim the display screen of the processor-based system.

12. The system of claim 11 wherein said storage stores instructions that enable the processor to initiate the progressive dimming of the display before implementing the transition to the lower power consumption state.

13. The system of claim 11 wherein said storage stores the instructions that enable the processor to determine whether the processor-based system has been inactive.

14. The system of claim 13 wherein said storage stores the instructions that enable the processor to determine whether the processor-based system has been inactive for a time period exceeding a time limit.

15. The system of claim 11 wherein said storage stores the instructions that enable the processor to power down the processor-based system to a lower power consumption state after progressively dimming the display screen.
